(19) United States
(12) Patent Application Publication
(10) Pub. No.: US 2020/0365180 A1
(43) Pub. Date: Nov. 19, 2020

(54) ALUMINUM ALLOY SUBSTRATE FOR MAGNETIC DISKS, METHOD FOR PRODUCING SAME, AND MAGNETIC DISK WHICH USES SAID ALUMINUM ALLOY SUBSTRATE FOR MAGNETIC DISKS

(71) Applicants: UACJ CORPORATION, Tokyo (JP); FURUKAWA ELECTRIC CO., LTD., Tokyo (JP)

(72) Inventors: Kotaro KITAWAKI, Tokyo (JP); Makoto YONEMITSU, Tokyo (JP); Takashi NAKAYAMA, Tokyo (JP); Toshihiro NAKAMURA, Tokyo (JP); Ryo SAKAMOTO, Tokyo (JP); Hideyuki HATAKEYAMA, Tokyo (JP)

(21) Appl. No.: 16/765,911

(22) PCT Filed: Aug. 22, 2018
(86) PCT No.: PCT/JP2018/031019

§ 371 Date: May 21, 2020

(30) Foreign Application Priority Data
Nov. 22, 2017 (JP) 2017-224297
Jun. 1, 2018 (JP) 2018-106052

(51) Int. Cl. G11B 5/73; G11B 5/858; G11B 5/64

(52) U.S. Cl. CPC G11B 5/73919; G11B 5/645; G11B 5/858

(57) ABSTRACT

There are provided: an aluminum alloy substrate for a magnetic disk, in which the product of the sheet thickness and loss factor of the substrate is 0.7×10⁻³ or more; a method for producing the aluminum alloy substrate for a magnetic disk; and a magnetic disk, in which an electroless Ni—P plating treatment layer and a magnetic layer formed thereon are disposed on a surface of the aluminum alloy substrate for a magnetic disk.

### TECHNICAL FIELD

The present disclosure relates to: an aluminum alloy substrate for a magnetic disk, excellent in shock resistance; a method for producing the aluminum alloy substrate for a magnetic disk; and a magnetic disk using the aluminum alloy substrate for a magnetic disk.

### BACKGROUND ART

Magnetic disks used in storage devices for computers are produced using substrates that have favorable plating properties and are excellent in mechanical characteristics and workability. For example, such a magnetic disk is produced with: a substrate based on an aluminum alloy according to JIS 5086 (including 3.5 to 4.5 mass % of Mg, 0.50 mass % or less of Fe, 0.40 mass % or less of Si, 0.20 to 0.70 mass % of Mn, 0.05 to 0.25 mass % of Cr, 0.10 mass % or less of Cu, 0.15 mass % or less of Ti, and 0.25 mass % or less of Zn, with a balance of Al and unavoidable impurities); and the like.

Common magnetic disks are produced by first producing an annular aluminum alloy substrate, plating the aluminum alloy substrate, and then depositing a magnetic substance on a surface of the aluminum alloy substrate.

For example, a magnetic disk made of an aluminum alloy according to the JIS 5086 alloy is produced by the following production steps. First, an aluminum alloy material allowed to contain predetermined chemical components is cast to obtain an ingot, and the ingot is subjected to hot rolling and then to cold rolling to produce a rolled material having a thickness required for the magnetic disk. It is preferable to anneal the rolled material in the cold rolling and/or the like, as needed. Then, the rolled material is stamped to have an annular shape. In order to eliminate distortion and/or the like occurring in the production steps, an aluminum alloy sheet allowed to have an annular shape is layered thereon, and the resultant is subjected to pressurization annealing in which the resultant is flattened by annealing the resultant while pressurizing both surfaces in the upper limit of the resultant. Thus, an annular aluminum alloy substrate is produced.

The annular aluminum alloy substrate produced in such a manner is subjected to cutting work, grinding work, degreasing, etching, and zincate treatment (Zn substitution treatment) as pretreatment and then to electroless plating with Ni—P which is a rigid non-magnetic metal as undercoat treatment. The plated surface is subjected to polishing, followed by sputtering a magnetic substance on the Ni—P electroless-plated surface, to produce the magnetic disk made of an aluminum alloy.

In recent years, larger-capacity and densified magnetic disks have been demanded due to the needs of multimedia and the like. The further higher capacity has resulted in an increase in the number of magnetic disks placed in a storage device. Thus, thinned magnetic disks have also been demanded. However, there is a problem that strength is decreased by thinning an aluminum alloy substrate for a magnetic disk. A decrease in strength results in the deterioration of shock resistance indicating the degree of the inhibition of the deformation of a substrate. Therefore, there has been a demand for improving the shock resistance of aluminum alloy substrates.

However, thinning and enhanced speed result in an increase in exciting force caused by a decrease in rigidity and an increase in fluid force due to high-speed rotation, thereby causing disk flutter to be more likely to occur. This is because high-speed rotation of magnetic disks causes unstable airflow to be generated between the disks, and the airflow results in vibration (fluttering) of the magnetic disks. Such a phenomenon is considered to occur because the low rigidity of a substrate results in the increased vibration of the magnetic disks, and a head is incapable of following such a variation. The occurrence of fluttering results in an increase in the positioning error of a head which is a reader. Therefore, a reduction in disk flutter has been earnestly demanded.

Moreover, the field of storage devices has faced severe cost competition, and a reduction in cost due to improvement in productivity and the like has also been earnestly demanded.

In light of such actual circumstances, aluminum alloy substrates for magnetic disks having high strength and smoothness with an excellent plated surface have been earnestly desired and examined in recent years. For example, Patent Literature 1 proposes a method in which a large amount of Mg contributing to improvement in the strength of an aluminum alloy sheet is allowed to be contained to improve shock resistance.

### CITATION LIST

### Patent Literature

Patent Literature 1: Unexamined Japanese Patent Application Kokai Publication No. 2006-241513

### SUMMARY OF INVENTION

### Technical Problem

However, in the method in which only the strength is improved by increasing the amount of Mg, disclosed in Patent Literature 1, it has been impossible to greatly suppress the deterioration of shock resistance, and it has been impossible to obtain objective favorable shock resistance under present circumstances.

The present disclosure was made under such actual circumstances with an objective to provide an aluminum alloy substrate for a magnetic disk, excellent in shock resistance, a method for producing the aluminum alloy substrate for a magnetic disk, and a magnetic disk using the aluminum alloy substrate for a magnetic disk.

### Solution to Problem

In other words, claim 1 of the present disclosure describes an aluminum alloy substrate for a magnetic disk, wherein a product of a sheet thickness and a loss factor of the aluminum alloy substrate is 0.7×10⁻³ or more.

Claim 2 of the present disclosure describes that the aluminum alloy substrate has a Young's modulus of 70 GPa or more and a proof stress of 70 MPa or more, in accordance with claim 1.

Claim 3 of the present disclosure describes the aluminum alloy substrate for a magnetic disk, including an aluminum alloy including one or more selected from a group comprising 0.10 to 3.00 mass % of Fe and 0.10 to 3.00 mass % of Mn, with a balance of Al and unavoidable impurities, in accordance with claim 1 or 2.

Claim 4 of the present disclosure describes that the aluminum alloy further includes one or more selected from a group comprising 0.100 to 5.000 mass % of Mg, 0.100 to 5.000 mass % of Ni, 0.010 to 5.000 mass % of Cr, 0.010 to 5.000 mass % of Zr, 0.005 to 5.000 mass % of Zn, 0.005 to 5.000 mass % of Cu, and 0.10 to 0.40 mass % of Si, in accordance with any one of claims 1 to 3.

Claim 5 of the present disclosure describes that the aluminum alloy further includes one or more selected from a group comprising Ti, B, and V of which a total of contents is 0.005 to 5.000 mass %, in accordance with any one of claims 1 to 4.

Claim 6 of the present disclosure describes a magnetic disk, wherein an electroless Ni—P plating treatment layer and a magnetic layer formed thereon are disposed on a surface of the aluminum alloy substrate according to any one of claims 1 to 5.

Claim 7 of the present disclosure describes a method for producing the aluminum alloy substrate according to any one of claims 1 to 5, the method including a semi-continuous casting step of semi-continuously casting an ingot using the aluminum alloy, a hot-rolling step of hot-rolling the ingot, a cold-rolling step of cold-rolling the hot-rolled sheet, a disk blank stamping step of stamping the cold-rolled sheet to have an annular shape, a pressurization annealing step of subjecting the stamped disk blank to pressurization annealing, a cutting/grinding step of performing cutting work and grinding work of the blank subjected to the pressurization annealing, and a heat treatment step of heat-treating the cut and ground blank, wherein heating retention of the blank is performed for 0.5 to 10.0 hours at 130 to 280° C. in the heat treatment step.

Claim 8 of the present disclosure describes that a homogenization heat treatment step of performing homogenization heat treatment of the ingot is further included between the semi-continuous casting step and the hot-rolling step, in accordance with claim 7.

Claim 9 of the present disclosure describes that an annealing treatment step of annealing the rolled sheet is further included before or in the cold-rolling step, in accordance with claim 7 or 8.

Claim 10 of the present disclosure describes a method for producing the aluminum alloy substrate according to any one of claims 1 to 5, the method including a continuous casting step of continuously casting a cast sheet using the aluminum alloy, a cold-rolling step of cold-rolling the cast sheet, a disk blank stamping step of stamping the cold-rolled sheet to have an annular shape, a pressurization annealing step of subjecting the stamped disk blank to pressurization annealing, a cutting/grinding step of performing cutting work and grinding work of the blank subjected to the pressurization annealing, and a heat treatment step of heat-treating the cut and ground blank, wherein heating retention of the blank is performed for 0.5 to 10.0 hours at 130 to 280° C. in the heat treatment step.

Claim 11 of the present disclosure describes that an annealing treatment step of annealing the cast sheet or the rolled sheet is further included before or in the cold-rolling step, in accordance with claim 10.

### Advantageous Effects of Invention

In accordance with the present disclosure, there can be provided a substrate for a magnetic disk, excellent in shock resistance, a method for producing the substrate for a magnetic disk, and a magnetic disk using the substrate for a magnetic disk.

### BRIEF DESCRIPTION OF DRAWINGS

FIG. 1 is a flow diagram illustrating a method for producing an aluminum alloy substrate for a magnetic disk according to the present disclosure.

### DESCRIPTION OF EMBODIMENTS

The present inventors focused on the relationships between the shock resistance of a substrate and the material of the substrate, intensively researched the relationships between such characteristics and the characteristics of the substrate (magnetic disk material), and found that not only strength but also a loss factor greatly influences the shock resistance. As a result, the present inventors found that an aluminum alloy substrate for a magnetic disk in which the product of the sheet thickness and loss factor of the substrate is 0.7×10⁻³ or more is improved in shock resistance. The present inventors thus accomplished the present disclosure on the basis of such findings.

The aluminum alloy substrate for a magnetic disk according to the present disclosure will be described in detail below.

The product of a sheet thickness and a loss factor, a Young's modulus, and a proof stress are described as the characteristics of the aluminum alloy substrate for a magnetic disk according to the present disclosure (hereinafter, may be simply referred to as “substrate”).

1. Product of Sheet Thickness and Loss Factor of Substrate

The effect of improving the shock resistance of the substrate is exhibited by improving the loss factor of a substrate. This is because when a force is applied to the substrate in, for example, a drop of an HDD, thereby causing vibrations of the substrate, contact between the substrate and another substrate can be avoided to enable prevention of plastic deformation caused by the contact between the substrates since a higher loss factor results in shorter time for which the vibrations of the substrate end. An appropriate loss factor greatly varies according to the sheet thickness of the substrate. This is because a less sheet thickness results in a less drag force against an exciting force caused by fluid. It was found that a substrate excellent in shock resistance is obtained in a case in which the product of the loss factor and sheet thickness (unit: mm) of the substrate is 0.7×10⁻³ or more. Therefore, the product of the sheet thickness and loss factor of the substrate is set at 0.7×10⁻³ or more. The product of the sheet thickness and loss factor of the substrate is preferably 0.8×10⁻³ or more, and more preferably 0.9×10⁻³ or more. The upper limit of the product of the sheet thickness and loss factor of the substrate is not particularly limited, but logically depends on alloy composition and product conditions, and is around 10.0×10⁻³ in the present disclosure.

A loss factor is a value obtained by dividing the natural logarithm of the ratio between amplitudes, next to each other, of a damped free vibration waveform by π. Assuming that n^{th} amplitude at a time of to is an, and, likewise, n+1^{th} to n+m^{th} amplitudes are aₙ₊₁ to aₙ₊ₘ, the loss factor is represented by {(1/m)×ln(an/aₙ₊ₘ)}/π.

2. Young's Modulus and Proof Stress of Substrate

The Young's modulus and proof stress of the substrate, effective for further improving the shock resistance of the aluminum alloy substrate for a magnetic disk, will now be described.

2-1. Young's Modulus of Substrate:

The effect of improving the shock resistance of the substrate is exhibited by improving the Young's modulus of the aluminum alloy substrate. This is because when a force is applied to a substrate in, for example, a drop of an HDD, thereby causing vibrations of the substrate, a higher Young's modulus enables deformation caused by the vibrations of the substrate to be kept in an elastic region, and the plastic deformation of the substrate can be prevented. When the Young's modulus of the substrate is 70 GPa or more, the shock resistance of the aluminum alloy substrate can be further enhanced. Therefore, the Young's modulus of the substrate is preferably 70 GPa or more, more preferably 71 GPa or more, and still more preferably 72 GPa or more. The upper limit of the Young's modulus of the substrate is not particularly limited, but logically depends on alloy composition and production conditions, and is around 90 GPa in the present disclosure.

2-2. Proof Stress of Substrate:

The effect of improving the shock resistance of the substrate is exhibited by improving the proof stress of the aluminum alloy substrate. This is because when a force is applied to a substrate in, for example, a drop of an HDD, thereby causing vibrations of the substrate, a higher proof stress enables deformation caused by the vibrations of the substrate to be kept in an elastic region, and the plastic deformation of the substrate can be prevented. When the proof stress of the substrate is 70 MPa or more, the shock resistance of the aluminum alloy substrate can be further enhanced. Therefore, the proof stress of the substrate is preferably 70 MPa or more, more preferably 80 MPa or more, and still more preferably 90 MPa or more. The upper limit of the proof stress of the substrate is not particularly limited, but logically depends on alloy composition and production conditions, and is around 300 MPa in the present disclosure.

3. Alloy Composition of Aluminum Alloy

An aluminum alloy used in the aluminum alloy substrate for a magnetic disk according to the present disclosure may include, as first selective elements, one or more selected from the group comprising 0.10 to 3.00 mass % (hereinafter, simply referred to as “%”) of Fe and 0.10 to 3.00% of Mn in order to further improve shock resistance and plating properties.

The above-described aluminum alloy may further include, as second selective elements, one or more selected from the group comprising 0.100 to 5.000% of Mg, 0.100 to 5.000% of Ni, 0.010 to 5.000% of Cr, 0.010 to 5.000% of Zr, 0.005 to 5.000% of Zn, 0.005 to 5.000% of Cu, and 0.10 to 0.40% of Si.

In addition, the above-described aluminum alloy may further include, as third selective elements, one or more selected from the group comprising Ti, B, and V of which the total of the contents is 0.005 to 5.000%.

Each of the selective elements described above will be described below.

Fe:

Fe exists principally as second phase particles (Al—Fe-based intermetallic compound or the like), exists to be partly solid-dissolved in a matrix, and exhibits the effect of improving the loss factor, Young's modulus, and strength of the aluminum alloy substrate. Application of vibrations to such a material results in immediate absorption of vibrational energy due to the interaction between the second phase particles and dislocations, thereby obtaining a favorable loss factor. In addition, an increase in the second phase particles of which the Young's modulus is higher than that of an aluminum base material results in improvement in Young's modulus. Further, an increase in the second phase particles results in improvement in strength due to dispersion strength. The effect of improving the loss factor, Young's modulus, and strength of the aluminum alloy substrate can be further enhanced by allowing the content of Fe in the aluminum alloy to be 0.10% or more. Generation of a large number of coarse Al—Fe-based intermetallic compound particles is inhibited by allowing the content of Fe in the aluminum alloy to be 3.00% or less. As a result, such coarse Al—Fe-based intermetallic compound particles can be inhibited from falling off, thereby generating large recesses, in etching, zincate treatment, cutting work, and grinding work, to further enhance the effect of improving the smoothness of a plated surface, and the peeling of plating can be further inhibited. In addition, the deterioration of workability in a rolling step can be further inhibited. Therefore, the content of Fe in the aluminum alloy is preferably set in a range of 0.10 to 3.00%, and more preferably set in a range of 0.60 to 2.40%.

Mn:

Mn exists as second phase particles (Al—Mn-based intermetallic compound or the like), and exhibits the effect of improving the loss factor, Young's modulus, and strength of the aluminum alloy substrate. Application of vibrations to such a material results in immediate absorption of vibrational energy due to the interaction between the second phase particles and dislocations, thereby obtaining a favorable loss factor. In addition, an increase in the second phase particles of which the Young's modulus is higher than that of an aluminum base material results in improvement in Young's modulus. Further, an increase in the second phase particles results in improvement in strength due to dispersion strength. The effect of improving the loss factor, Young's modulus, and strength of the aluminum alloy substrate can be further enhanced by allowing the content of Mn in the aluminum alloy to be 0.10% or more. Generation of a large number of coarse Al—Mn-based intermetallic compound particles is inhibited by allowing the content of Mn in the aluminum alloy to be 3.00% or less. As a result, such coarse Al—Mn-based intermetallic compound particles can be inhibited from falling off, thereby generating large recesses, in etching, zincate treatment, cutting work, and grinding work, to further enhance the effect of improving the smoothness of a plated surface, and the peeling of plating can be further inhibited. In addition, the deterioration of workability in the rolling step can be further inhibited. Therefore, the content of Mn in the aluminum alloy is preferably set in a range of 0.10 to 3.00%, and more preferably set in a range of 0.10 to 1.50%.

Mg:

Mg exists to be principally solid-dissolved in a matrix, exists partly as second phase particles (Mg—Si-based intermetallic compound or the like), and exhibits the effect of improving the strength and Young's modulus of the aluminum alloy substrate. The effect of improving the strength and Young's modulus of the aluminum alloy substrate can be further enhanced by allowing the content of Mg in the aluminum alloy to be 0.100% or more. A decrease in loss factor can be further suppressed by allowing the content of Mg in the aluminum alloy to be 5.000% or less. Therefore, the content of Mg in the aluminum alloy is preferably set in a range of 0.100 to 5.000%, and more preferably set in a range of 0.100 to 0.800.

Ni:

Ni exists principally as second phase particles (Al—Ni-based intermetallic compound or the like), and exhibits the effect of improving the Young's modulus and strength of the aluminum alloy substrate. The effect of improving the Young's modulus and strength of the aluminum alloy substrate can be further enhanced by allowing the content of Ni in the aluminum alloy to be 0.100% or more. Generation of a large number of coarse Al—Ni-based intermetallic compound particles is inhibited by allowing the content of Ni in the aluminum alloy is 5.000% or less. As a result, such coarse Al—Ni-based intermetallic compound particles can be inhibited from falling off, thereby generating large recesses, in etching, zincate treatment, cutting work, and grinding work, and the deterioration of the smoothness of a plated surface and the peeling of plating can be further inhibited. In addition, the deterioration of workability in the rolling step can be further inhibited. Therefore, the content of Ni in the aluminum alloy is preferably set in a range of 0.100 to 5.000%, and more preferably set in a range of 0.100 to 1.000%.

Cr:

Cr exists principally as second phase particles (Al—Cr-based intermetallic compound or the like), and exhibits the effect of improving the Young's modulus and strength of the aluminum alloy substrate. The effect of improving the Young's modulus and strength of the aluminum alloy substrate can be further enhanced by allowing the content of Cr in the aluminum alloy to be 0.010% or more. Generation of a large number of coarse Al—Cr-based intermetallic compound particles is inhibited by allowing the content of Cr in the aluminum alloy to be 5.000% or less. As a result, such coarse Al—Cr-based intermetallic compound particles can be inhibited from falling off, thereby generating large recesses, in etching, zincate treatment, cutting work, and grinding work, and the deterioration of the smoothness of a plated surface and the peeling of plating can be further inhibited. In addition, the deterioration of workability in the rolling step can be further inhibited. Therefore, the content of Cr in the aluminum alloy is preferably set in a range of 0.010 to 5.000%, and more preferably set in a range of 0.100 to 1.000%.

Zr:

Zr exists principally as second phase particles (Al—Zr-based intermetallic compound or the like), and exhibits the effect of improving the Young's modulus and strength of the aluminum alloy substrate. The effect of improving the Young's modulus and strength of the aluminum alloy substrate can be further enhanced by allowing the content of Zr in the aluminum alloy to be 0.010% or more. Generation of a large number of coarse Al—Zr-based intermetallic compound particles is inhibited by allowing the content of Zr in the aluminum alloy to be 5.000% or less. As a result, such coarse Al—Zr-based intermetallic compound particles can be inhibited from falling off, thereby generating large recesses, in etching, zincate treatment, cutting work, and grinding work, and the deterioration of the smoothness of a plated surface and the peeling of plating can be further inhibited. In addition, the deterioration of workability in the rolling step can be further inhibited. Therefore, the content of Zr in the aluminum alloy is preferably set in a range of 0.010 to 5.000%, and more preferably set in a range of 0.100 to 1.000%.

Zn:

Zn exhibits the effects of decreasing the amount of Al melted in zincate treatment and of uniformly, thinly, and minutely depositing a zincate coating film to improve smoothness and adhesiveness in a subsequent plating step. In addition, Zn forms second phase particles together with other added elements and exhibits the effect of improving a Young's modulus and strength. The effects of decreasing the amount of Al melted in the zincate treatment and of uniformly, thinly, and minutely depositing the zincate coating film to improve the smoothness of the plating can be further enhanced by allowing the content of Zn in the aluminum alloy to be 0.005% or more. The zincate coating film becomes uniform to enable the smoothness of the plated surface to be further inhibited from deteriorating, and the plating can be further inhibited from peeling, by allowing the content of Zn in the aluminum alloy to be 5.000% or less. In addition, the deterioration of the workability in the rolling step can be further inhibited. Therefore, the content of Zn in the aluminum alloy is preferably set in a range of 0.005 to 5.000%, and more preferably set in a range of 0.100 to 0.700.

Cu:

Cu exists principally as second phase particles (Al—Cu-based intermetallic compound or the like) and exhibits the effect of improving the strength and Young's modulus of the aluminum alloy substrate. In addition, the amount of Al dissolved in zincate treatment is decreased. Furthermore, the effect of uniformly, thinly, and minutely depositing a zincate coating film to improve smoothness in the subsequent plating step is exhibited. The effect of improving the Young's modulus and strength of the aluminum alloy substrate and the effect of improving smoothness can be further enhanced by allowing the content of Cu in the aluminum alloy to be 0.005% or more. In addition, generation of a large number of coarse Al—Cu-based intermetallic compound particles is inhibited by allowing the content of Cu in the aluminum alloy to be 5.000% or less. As a result, such coarse Al—Cu-based intermetallic compound particles can be inhibited from falling off, thereby generating large recesses, in etching, zincate treatment, cutting work, and grinding work, to further enhance the effect of improving the smoothness of the plated surface, and the peeling of the plating can be further inhibited. In addition, the deterioration of the workability in the rolling step can be further inhibited. Therefore, the content of Cu in the aluminum alloy is preferably set in a range of 0.005 to 5.000%, and more preferably set in a range of 0.005 to 1.000%.

Si:

Si exists as second phase particles (Si particles, Al—Fe—Si-based intermetallic compound, or the like), and exhibits the effect of improving the loss factor, Young's modulus, and strength of the aluminum alloy substrate. Application of vibrations to such a material results in immediate absorption of vibrational energy due to the interaction between the second phase particles and dislocations, thereby obtaining a favorable loss factor. In addition, an increase in the second phase particles of which the Young's modulus is higher than that of aluminum results in improvement in Young's modulus. Further, an increase in the second phase particles results in improvement in strength due to dispersion strength. The effect of improving the loss factor, Young's modulus, and strength of the aluminum alloy substrate can be further enhanced by allowing the content of Si in the aluminum alloy to be 0.100% or more. Generation of a large number of coarse Si particles is inhibited by allowing the content of Si in the aluminum alloy to be 0.400% or less. Such coarse Si particles can be inhibited from falling off, thereby generating large recesses, in etching, zincate treatment, cutting work, and grinding work, to further enhance the effect of improving the smoothness of a plated surface, and the peeling of plating can be further inhibited. In addition, the deterioration of workability in the rolling step can be further inhibited. Therefore, the content of Si in the aluminum alloy is preferably set in a range of 0.100 to 0.400%, and more preferably set in a range of 0.100 to 0.350%.

Ti, B, V:

Ti, B, and V form second phase particles (such as borides such as TiB₂, and Al₃Ti and Ti-V-B particles), which become crystal grain nuclei, in a solidification process in casting, and therefore enable crystal grains to be finer. As a result, plating properties are improved. In addition, the effect of reducing nonuniformity in the sizes of the second phase particles to reduce unevenness in decay rate, Young's modulus, and strength in the aluminum alloy substrate is exhibited by allowing the crystal grains to be finer. However, it is impossible to obtain the above-described effects when the total of the contents of Ti, B, and V is less than 0.005%. In contrast, even when the total of the contents of Ti, B, and V is more than 5.000%, the effects are saturated, and it is impossible to obtain further noticeable improvement effects. Therefore, the total of the contents of Ti, B, and V in the case of adding Ti, B, and V is preferably set in a range of 0.005 to 5.000%, and more preferably set in a range of 0.005 to 0.500%. When only any one of Ti, B, and V is contained, the total refers to the content of the one; when any two thereof are contained, the total refers to the total of the two; and when all the three thereof are contained, the total refers to the total of the three.

Other Elements:

In addition, the balance of the aluminum alloy used in the present disclosure comprises Al and unavoidable impurities. In such a case, examples of the unavoidable impurities include Ga and Sn, and the characteristics of the aluminum alloy substrate obtained in the present disclosure are not deteriorated when each and the total of the unavoidable impurities are less than 0.10% and less than 0.20%, respectively.

Such intermetallic compounds mean precipitates or crystallized products, and specifically refer to, for example, particles such as Al—Fe-based intermetallic compounds (Al₃Fe, Al₆Fe, Al₆(Fe, Mn), Al—Fe—Si, Al—Fe—Mn—Si, Al—Fe—Ni, Al—Cu—Fe, and the like) and Mg—Si-based intermetallic compounds (Mg₂Si and the like). Examples of other intermetallic compounds include Al—Mn-based intermetallic compounds (Al₆Mn and Al—Mn—Si), Al—Ni-based intermetallic compounds (Al₃Ni and the like), Al—Cu-based intermetallic compounds (Al₂Cu and the like), Al—Cr-based intermetallic compounds (Al₇Cr and the like), and Al—Zr-based intermetallic compounds (Al₃Zr and the like). The second phase particles include Si particles and the like, as well as the intermetallic compounds.

4. Method for Producing Aluminum Alloy Substrate for Magnetic Disk

Each step and process conditions of steps for producing the aluminum alloy substrate for a magnetic disk according to the present disclosure will be described in detail below.

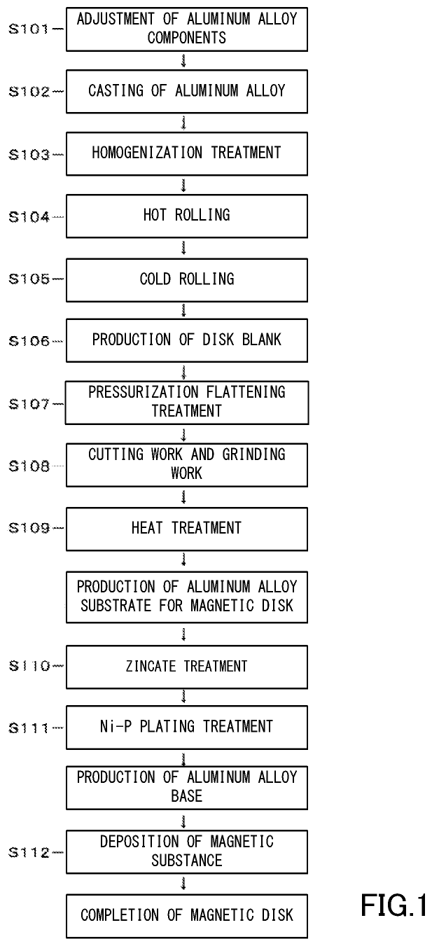

Methods for producing the aluminum alloy substrate for a magnetic disk according to the present disclosure and a magnetic disk using the aluminum alloy substrate are described with reference to a flow in FIG. 1. In such a case, adjustment of aluminum alloy components (step S101) to cold rolling (step S105) are steps for producing the aluminum alloy substrate, and production of a disk blank (step S106) to deposition of a magnetic substance (step S111) are steps for making the produced aluminum alloy substrate into the magnetic disk.

First, a molten metal of an aluminum alloy material having the component composition described above is prepared by heating and melting according to a usual method (step S101). Then, an aluminum alloy is cast from the prepared molten metal of the aluminum alloy material by a semi-continuous casting (DC casting) method, a continuous casting (CC casting) method, or the like (step S102). In such a case, the DC casting method and the CC casting method are as follows.

In the DC casting method, the heat of the molten metal poured through a spout is removed by a bottom block, the wall of a water-cooled mold, and cooling water directly discharged to the outer periphery of an ingot, and the molten metal is solidified and drawn downward as the ingot.

In the CC casting method, the molten metal is supplied into between a pair of rolls (or a belt caster and a block caster) through a casting nozzle, and a thin sheet is directly cast by removal of heat from the rolls.

A point of great difference between the DC casting method and the CC casting method is a cooling rate in casting. A feature of the CC casting method in which the cooling rate is high is in that the sizes of second phase particles in the CC casting method are smaller than those in the DC casting. In both the casting methods, each cooling rate in the casting is preferably set in a range of 0.1 to 1000° C./s. The setting of the cooling rate in the casting at 0.1 to 1000° C./s results in generation of a large number of second phase particles and in improvement in loss factor and Young's modulus. In addition, the amount of the solid solution of Fe is increased, and the effect of improving strength can be obtained. A cooling rate of less than 0.1° C./s in the casting may result in a decrease in the amount of the solid solution of Fe and in a decrease in strength. In contrast, when the cooling rate in the casting is more than 1000° C./s, the number of second phase particles may be decreased, and it may be impossible to sufficiently obtain a loss factor and a Young's modulus.

Then, the aluminum alloy ingot obtained by the DC casting is subjected to homogenization treatment as needed (step S103). In the case of performing the homogenization treatment, heat treatment at 280 to 620° C. for 0.5 to 30 hours is preferably performed, and heat treatment at 300 to 620° C. for 1 to 24 hours is more preferably performed. A heating temperature of less than 280° C. or a heating time of less than 0.5 hours in the homogenization treatment may result in insufficient homogenization treatment and in increased unevenness in the loss factors of aluminum alloy substrates. A heating temperature of more than 620° C. in the homogenization treatment may result in melting of the aluminum alloy ingot. A heating time of more than 30 hours in the homogenization treatment also results in the saturation of the effect thereof and prevents a further noticeable improvement effect from being obtained.

Then, the aluminum alloy ingot that has been subjected to the homogenization treatment as needed or has not been subjected to the homogenization treatment is hot-rolled to make a sheet material (step S104). When the hot rolling is performed, the conditions of the hot rolling are not particularly limited, but a hot-rolling start temperature is preferably set at 250 to 600° C., and a hot-rolling end temperature is preferably set at 230 to 450° C.

Then, the rolled sheet that has been hot-rolled or the cast sheet that has been cast by the continuous casting method is cold-rolled to make an aluminum alloy sheet of around 1.3 mm to 0.45 mm (step S105). The sheet is finished to have a needed product sheet thickness by the cold rolling. The conditions of the cold rolling are not particularly limited but may be determined depending on a needed product sheet strength and sheet thickness, and a rolling reduction is preferably set at 10 to 95%. Before or in the cold rolling, annealing treatment may be performed to secure cold-rolling workability. The annealing treatment is preferably performed under conditions of 300 to 450° C. and 0.1 to 10 hours in the case of, for example, batch-type heating and is preferably performed under conditions of retention at 400 to 500° C. and 0 to 60 seconds in the case of continuous heating. In such a case, a retention time of 0 second means that cooling is performed immediately after reaching a desired retention temperature.

In order to work the aluminum alloy sheet for the magnetic disk, the aluminum alloy sheet is stamped in an annular shape to produce a disk blank (step S106). Then, the disk blank is subjected to pressurization annealing in atmospheric air, for example, at 150 to 270° C. for 0.5 to 10 hours, to produce a flattened blank (step S107). Then, the blank is subjected to cutting work and grinding work (step S108), and to heat treatment in which the blank is retained for 0.5 to 10.0 hours in a range of 130 to 280° C. (step S109), to produce an aluminum alloy board.

A decrease in dislocations required for improving a loss factor can be suppressed to improve shock resistance by performing the heat treatment in which the blank is retained for 0.5 to 10.0 hours in a range of 130 to 280° C. in such a manner. A heat treatment temperature of more than 280° C. or a heat treatment time of more than 10.0 hours results in a decrease in dislocations, thereby thus decreasing a loss factor and deteriorating shock resistance. In contrast, a heat treatment temperature of less than 130° C. or a heat treatment time of less than 0.5 hours results in insufficient removal of strains introduced by the working, thereby thus deteriorating the flatness of the substrate due to variation with time and precluding use as the aluminum alloy substrate for a magnetic disk. Therefore, in the heat treatment of the cut and ground blank, the blank is retained for 0.5 to 10.0 hours in a range of 130 to 280° C. The temperature range is preferably 180 to 250° C., and the retention time is preferably 0.5 to 5.0 hours.

Then, a surface of the aluminum alloy substrate is subjected to degreasing, etching, and zincate treatment (Zn substitution treatment) (step S110). Further, the treated surface subjected to the zincate treatment is subjected to electroless Ni—P plating treatment as undercoat treatment (step S111), to produce an aluminum alloy base. Finally, a magnetic substance is deposited on the surface subjected to the electroless Ni—P plating treatment by sputtering (step S112), to make a magnetic disk.

### EXAMPLES

The present disclosure will be described in more detail below with reference to Examples. However, the present disclosure is not limited thereto.

First, an example of an aluminum alloy substrate for a magnetic disk using an aluminum alloy cast by a DC casting method will be described as a first example. Each alloy material with component composition set forth in Tables 1 to 3 was melted to make a molten aluminum alloy according to a usual method (step S101). In Tables 1 to 3, “-” denotes less than a measurement limit value.

TABLE 1

| | Component Composition (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | Unavoidable |
| No. | Fe | Mn | Si | Ni | Cu | Mg | Cr | Zr | Zn | Ti | B | V | Ti + B + V | Impurities |
| A1 | 0.10 | 0.10 | — | 0.201 | 0.021 | 0.205 | 0.201 | 0.203 | 0.230 | — | — | — | 0.000 | Bal. |
| A2 | 0.60 | 0.20 | — | — | — | — | — | — | — | — | — | — | 0.000 | Bal. |
| A3 | 0.80 | — | 0.20 | — | — | — | — | — | — | — | — | — | 0.000 | Bal. |
| A4 | 0.90 | — | — | 0.204 | — | — | — | — | — | — | — | — | 0.000 | Bal. |
| A5 | 1.00 | — | — | — | 0.021 | — | — | — | — | — | — | — | 0.000 | Bal. |
| A6 | 1.20 | — | — | — | — | 0.205 | — | — | — | — | — | — | 0.000 | Bal. |
| A7 | 1.50 | — | — | — | — | — | 0.201 | — | — | — | — | — | 0.000 | Bal. |
| A8 | 1.80 | — | — | — | — | — | — | 0.203 | — | — | — | — | 0.000 | Bal. |
| A9 | 2.40 | — | — | — | — | — | — | — | 0.230 | — | — | — | 0.000 | Bal. |
| A10 | 2.90 | — | — | — | — | — | — | — | — | 0.060 | 0.001 | 0.020 | 0.081 | Bal. |
| A11 | 1.50 | 0.10 | — | — | — | — | — | — | — | — | — | — | 0.000 | Bal. |
| A12 | 1.50 | 0.30 | — | — | — | — | — | — | — | — | — | — | 0.000 | Bal. |
| A13 | — | 1.50 | — | — | — | — | — | — | — | — | — | — | 0.000 | Bal. |
| A14 | — | 2.90 | — | — | — | — | — | — | — | — | — | — | 0.000 | Bal. |
| A15 | 1.50 | — | 0.10 | — | — | — | — | — | — | — | — | — | 0.000 | Bal. |
| A16 | 1.50 | — | 0.15 | — | — | — | — | — | — | — | — | — | 0.000 | Bal. |
| A17 | 1.50 | — | 0.35 | — | — | — | — | — | — | — | — | — | 0.000 | Bal. |
| A18 | 1.50 | — | 0.40 | — | — | — | — | — | — | — | — | — | 0.000 | Bal. |
| A19 | 1.50 | — | — | 0.102 | — | — | — | — | — | — | — | — | 0.000 | Bal. |
| A20 | 1.50 | — | — | 0.993 | — | — | — | — | — | — | — | — | 0.000 | Bal. |
| A21 | 1.50 | — | — | 4.900 | — | — | — | — | — | — | — | — | 0.000 | Bal. |
| A22 | 1.50 | — | — | — | 0.005 | — | — | — | — | — | — | — | 0.000 | Bal. |
| A23 | 1.50 | — | — | — | 0.851 | — | — | — | — | — | — | — | 0.000 | Bal. |
| A24 | 1.50 | — | — | — | 4.862 | — | — | — | — | — | — | — | 0.000 | Bal. |
| A25 | 1.50 | — | — | — | — | 0.105 | — | — | — | — | — | — | 0.000 | Bal. |
| A26 | 1.50 | — | — | — | — | 0.798 | — | — | — | — | — | — | 0.000 | Bal. |
| A27 | 1.50 | — | — | — | — | 4.992 | — | — | — | — | — | — | 0.000 | Bal. |
| A28 | 1.50 | — | — | — | — | — | 0.010 | — | — | — | — | — | 0.000 | Bal. |
| A29 | 1.50 | — | — | — | — | — | 0.950 | — | — | — | — | — | 0.000 | Bal. |
| A30 | 1.50 | — | — | — | — | — | 4.950 | — | — | — | — | — | 0.000 | Bal. |

TABLE 2

| | Component Composition (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | Unavoidable |
| No. | Fe | Mn | Si | Ni | Cu | Mg | Cr | Zr | Zn | Ti | B | V | Ti + B + V | Impurities |
| A31 | 1.50 | — | — | — | — | — | — | 0.010 | — | — | — | — | 0.000 | Bal. |
| A32 | 1.80 | — | — | — | — | — | — | 0.950 | — | — | — | — | 0.000 | Bal. |
| A33 | 1.80 | — | — | — | — | — | — | 4.950 | — | — | — | — | 0.000 | Bal. |
| A34 | 1.80 | — | — | — | — | — | — | — | 0.005 | — | — | — | 0.000 | Bal. |
| A35 | 1.50 | — | — | — | — | — | — | — | 0.550 | — | — | — | 0.000 | Bal. |
| A36 | 1.50 | — | — | — | — | — | — | — | 4.950 | — | — | — | 0.000 | Bal. |
| A37 | 0.80 | 0.30 | 0.10 | 0.932 | 0.021 | 0.303 | 0.150 | 0.153 | 0.350 | 0.005 | 0.001 | 0.001 | 0.007 | Bal. |
| A38 | 1.50 | 0.30 | 0.10 | 0.954 | 0.020 | 0.304 | 0.151 | 0.152 | 0.351 | 0.454 | 0.023 | 0.012 | 0.489 | Bal. |
| A39 | 2.30 | 0.30 | 0.10 | 0.943 | 0.020 | 0.300 | 0.152 | 0.150 | 0.350 | 4.754 | 0.053 | 0.082 | 4.889 | Bal. |
| A40 | 0.60 | — | — | — | — | — | — | — | — | — | — | — | 0.000 | Bal. |
| A41 | 1.80 | — | — | — | — | — | — | — | — | — | — | — | 0.000 | Bal. |
| A42 | 2.40 | — | — | — | — | — | — | — | — | — | — | — | 0.000 | Bal. |
| A43 | 3.50 | — | — | — | — | — | — | — | — | — | — | — | 0.000 | Bal. |
| A44 | — | 3.50 | — | — | — | — | — | — | — | — | — | — | 0.000 | Bal. |
| A45 | 1.50 | — | 1.00 | — | — | — | — | — | — | — | — | — | 0.000 | Bal. |
| A46 | 1.50 | — | — | 5.502 | — | — | — | — | — | — | — | — | 0.000 | Bal. |
| A47 | 1.50 | — | — | — | 5.521 | — | — | — | — | — | — | — | 0.000 | Bal. |
| A48 | 1.50 | — | — | — | — | — | 5.501 | — | — | — | — | — | 0.000 | Bal. |
| A49 | 1.50 | — | — | — | — | — | — | 5.503 | — | — | — | — | 0.000 | Bal. |
| A50 | 1.50 | — | — | — | — | — | — | — | 5.935 | — | — | — | 0.000 | Bal. |
| A51 | 1.50 | — | — | — | — | — | — | — | — | 0.012 | — | — | 0.012 | Bal. |
| A52 | 1.50 | — | — | — | — | — | — | — | — | 0.393 | — | — | 0.393 | Bal. |
| A53 | 1.50 | — | — | — | — | — | — | — | — | — | — | 0.014 | 0.014 | Bal. |
| A54 | 1.50 | — | — | — | — | — | — | — | — | — | — | 0.353 | 0.353 | Bal. |
| A55 | 1.50 | — | — | — | — | — | — | — | — | 0.054 | — | 0.051 | 0.105 | Bal. |
| A56 | 1.50 | — | — | — | — | — | — | — | — | 0.232 | — | 0.215 | 0.447 | Bal. |

TABLE 3

| | Component Composition (mass %) | | | | | | | | | | | | | |
|---|---|---|---|---|---|---|---|---|---|---|---|---|---|---|
| | | | | | | | | | | | | | | Al + |
| Alloy | | | | | | | | | | | | | | Unavoidable |
| No. | Fe | Mn | Si | Ni | Cu | Mg | Cr | Zr | Zn | Ti | B | V | Ti + B + V | Impurities |
| AC1 | 0.05 | — | — | — | — | — | — | — | — | — | — | — | 0.000 | Bal. |
| AC2 | — | 0.05 | — | — | — | — | — | — | — | — | — | — | 0.000 | Bal. |
| AC3 | — | — | 0.05 | — | — | — | — | — | — | — | — | — | 0.000 | Bal. |
| AC4 | — | — | — | 0.051 | — | — | — | — | — | — | — | — | 0.000 | Bal. |
| AC5 | — | — | — | — | 0.001 | — | — | — | — | — | — | — | 0.000 | Bal. |
| AC6 | — | — | — | — | — | 5.501 | — | — | — | — | — | — | 0.000 | Bal. |
| AC7 | 0.01 | — | 0.01 | — | 0.021 | 5.812 | 0.051 | — | 0.312 | | — | — | 0.000 | Bal. |
| AC8 | — | — | — | — | — | — | 0.001 | — | — | — | — | — | 0.000 | Bal. |
| AC9 | — | — | — | — | — | — | — | 0.001 | — | — | — | — | 0.000 | Bal. |
| AC10 | — | — | — | — | — | — | — | — | 0.001 | — | — | — | 0.000 | Bal. |
| AC11 | 1.20 | — | — | — | — | — | — | — | — | — | — | — | 0.000 | Bal. |
| AC12 | 1.20 | — | — | — | — | — | — | — | — | — | — | — | 0.000 | Bal. |
| AC13 | 1.20 | — | — | — | — | — | — | — | — | — | — | — | 0.000 | Bal. |
| AC14 | 1.20 | — | — | — | — | — | — | — | — | — | — | — | 0.000 | Bal. |
| AC15 | — | 0.80 | — | — | — | — | — | — | — | — | — | — | 0.000 | Bal. |
| AC16 | — | 0.80 | — | — | — | — | — | — | — | — | — | — | 0.000 | Bal. |
| AC17 | 0.05 | — | 0.30 | — | — | — | — | — | — | — | — | — | 0.000 | Bal. |
| AC18 | 0.05 | — | 0.30 | — | — | — | — | — | — | — | — | — | 0.000 | Bal. |
| AC19 | 1.50 | 0.30 | 0.10 | 0.964 | 0.021 | 0.301 | 0.152 | 0.153 | 0.351 | — | — | — | 0.000 | Bal. |
| AC20 | 1.50 | 0.30 | 0.10 | 0.951 | 0.022 | 0.303 | 0.151 | 0.152 | 0.352 | — | — | — | 0.000 | Bal. |

Then, the molten aluminum alloy was cast by the DC casting method, to produce an ingot having a thickness of 400 mm (step S102). Both surfaces of the ingot were faced in 15 mm before homogenization treatment.

Then, the homogenization treatment was performed for 10 hours at 380° C. except for No. A2 (step S103). Then, hot rolling was performed under conditions of a hot-rolling start temperature of 370° C. and a hot-rolling end temperature of 230° C., to make a hot-rolled sheet having a sheet thickness of 3.0 mm (step S104).

After the hot rolling, the hot-rolled sheets of the alloys Nos. A3, A5, and AC1 were subjected to annealing (batch type) under conditions of 300° C. and 2 hours. All the hot-rolled sheets produced in such a manner were rolled to have a final sheet thickness of 0.8 mm by cold rolling (rolling reduction of 73.3%), to make aluminum alloy sheets (step S105). Disk blanks were stamped and produced to have an annular shape with an outer diameter of 96 mm and an inner diameter of 24 mm from the aluminum alloy sheets (step S106).

Each of the disk blanks produced in such a manner was subjected to pressurization annealing (pressurization flattening treatment) for 3 hours at 230° C. (step S107). The disk blank was subjected to end-surface preparation (cutting work) to have an outer diameter of 95 mm and an inner diameter of 25 mm and subjected to grinding work (grinding work of surface of 25 μm) (step S108). Then, heat treatment was performed under conditions set forth in Tables 4 to 6 (step S109). A retention time of “0.0 h” in a range of 130 to 280° C. in Comparative Example 12 in Table 6 represents a heating retention temperature of less than 130° C.

TABLE 4

Heat Treatment Conditions

| | | Heating | Retention Time |
|---|---|---|---|
| | | Retention | in Range of |
| | | Temperature | 130 to 280° C. |
| | Alloy No. | (° C.) | (h) |
| Example 1 | A1 | 130 | 10.0 |
| Example 2 | A2 | 180 | 5.0 |
| Example 3 | A3 | 200 | 0.5 |
| Example 4 | A4 | 230 | 1.0 |
| Example 5 | A5 | 230 | 1.0 |
| Example 6 | A6 | 250 | 1.0 |
| Example 7 | A7 | 230 | 1.0 |
| Example 8 | A8 | 230 | 1.0 |
| Example 9 | A9 | 200 | 1.0 |
| Example 10 | A10 | 280 | 1.0 |
| Example 11 | A11 | 230 | 1.0 |
| Example 12 | A12 | 230 | 1.0 |
| Example 13 | A13 | 230 | 1.0 |
| Example 14 | A14 | 230 | 1.0 |
| Example 15 | A15 | 230 | 1.0 |
| Example 16 | A16 | 230 | 1.0 |
| Example 17 | A17 | 230 | 1.0 |
| Example 18 | A18 | 230 | 1.0 |
| Example 19 | A19 | 230 | 1.0 |
| Example 20 | A20 | 230 | 1.0 |
| Example 21 | A21 | 230 | 1.0 |
| Example 22 | A22 | 230 | 1.0 |
| Example 23 | A23 | 230 | 1.0 |
| Example 24 | A24 | 230 | 1.0 |
| Example 25 | A25 | 230 | 1.0 |
| Example 26 | A26 | 230 | 1.0 |
| Example 27 | A27 | 230 | 1.0 |
| Example 28 | A28 | 230 | 1.0 |
| Example 29 | A29 | 230 | 1.0 |
| Example 30 | A30 | 230 | 1.0 |

TABLE 5

Heat Treatment Conditions

| | | Heating | Retention Time |
|---|---|---|---|
| | | Retention | in Range of |
| | | Temperature | 130 to 280° C. |
| | Alloy No. | (° C.) | (h) |
| Example 31 | A31 | 230 | 1.0 |
| Example 32 | A32 | 230 | 1.0 |
| Example 33 | A33 | 230 | 1.0 |
| Example 34 | A34 | 230 | 1.0 |
| Example 35 | A35 | 230 | 1.0 |
| Example 36 | A36 | 230 | 1.0 |
| Example 37 | A37 | 230 | 1.0 |
| Example 38 | A38 | 230 | 1.0 |
| Example 39 | A39 | 230 | 1.0 |
| Example 40 | A40 | 230 | 1.0 |
| Example 41 | A41 | 230 | 1.0 |
| Example 42 | A42 | 230 | 1.0 |
| Example 43 | A43 | 230 | 1.0 |
| Example 44 | A44 | 230 | 1.0 |
| Example 45 | A45 | 230 | 1.0 |
| Example 46 | A46 | 230 | 1.0 |
| Example 47 | A47 | 230 | 1.0 |
| Example 48 | A48 | 230 | 1.0 |
| Example 49 | A49 | 230 | 1.0 |
| Example 50 | A50 | 230 | 1.0 |
| Example 51 | A51 | 230 | 1.0 |
| Example 52 | A52 | 230 | 1.0 |
| Example 53 | A53 | 230 | 1.0 |
| Example 54 | A54 | 230 | 1.0 |
| Example 55 | A55 | 230 | 1.0 |
| Example 56 | A56 | 230 | 1.0 |

TABLE 6

| | | Heat Treatment Conditions | |
|---|---|---|---|
| | | Heating | Retention Time |
| | | Retention | in Range of |
| | | Temperature | 130 to 280° C. |
| | Alloy No. | (° C.) | (h) |
| Comparative Example 1 | AC1 | 230 | 1.0 |
| Comparative Example 2 | AC2 | 230 | 1.0 |
| Comparative Example 3 | AC3 | 230 | 1.0 |
| Comparative Example 4 | AC4 | 230 | 1.0 |
| Comparative Example 5 | AC5 | 230 | 1.0 |
| Comparative Example 6 | AC6 | 230 | 1.0 |
| Comparative Example 7 | AC7 | 230 | 1.0 |
| Comparative Example 8 | AC8 | 230 | 1.0 |
| Comparative Example 9 | AC9 | 230 | 1.0 |
| Comparative Example 10 | AC10 | 230 | 1.0 |
| Comparative Example 11 | AC11 | 350 | 1.0 |
| Comparative Example 12 | AC12 | 100 | 0.0 |
| Comparative Example 13 | AC13 | 230 | 12.0 |
| Comparative Example 14 | AC14 | 230 | 0.3 |
| Comparative Example 15 | AC15 | 300 | 1.0 |
| Comparative Example 16 | AC16 | 230 | 12.0 |
| Comparative Example 17 | AC17 | 350 | 1.0 |
| Comparative Example 18 | AC18 | 230 | 12.0 |
| Comparative Example 19 | AC19 | 350 | 1.0 |
| Comparative Example 20 | AC20 | 230 | 12.0 |

The following evaluations of the aluminum alloy sheets obtained after the cold rolling (step S105) and the aluminum alloy substrates obtained after the heat treatment (step S109) were performed. Visual inspection of each sample was performed after the cold rolling. As a result, cracks of having a length of 30 to 50 mm were generated along a surface in Examples 17 and 18, and cracks having a length of more than 50 mm were generated along a surface in Examples 43 to 50. However, a portion in which no crack was generated was used as a sample, and subjected to trial production and evaluations. The flatness of each sample was measured just after the heat treatment step and after a lapse of 1 week following the heat treatment step. In Comparative Examples 12 and 14, flatness after a lapse of 1 week following the heat treatment step was deteriorated by 20 μm or more, and inappropriate for an aluminum alloy substrate for a magnetic disk, and the following evaluations were not performed.

[Loss Factor×Sheet Thickness]

A sample of 60 mm×8 mm was collected from the aluminum alloy substrate obtained after the heat treatment (step S109) step, a loss factor was measured by a vibration decay method, and loss factor×sheet thickness (mm) was calculated. The loss factor was measured at room temperature using a JE-RT type device manufactured by Nihon Techno-Plus Corp. In the evaluation of decay performance, a case in which loss factor×sheet thickness was 0.9×10⁻³ or more was evaluated as A (excellent), a case in which loss factor×sheet thickness was 0.8×10⁻³ or more and less than 0.9×10⁻³ was evaluated as B (good), a case in which loss factor×sheet thickness was 0.7×10⁻³ or more and less than 0.8×10⁻³ was evaluated as C (fair), and a case in which loss factor×sheet thickness was less than 0.7×10⁻³ was evaluated as D (poor). It is also acceptable to peel the plating of a magnetic disk or aluminum alloy base obtained after the heat treatment, collect a test piece from the substrate of which the surface of 10 μm was ground, and perform the evaluation. The results are set forth in Tables 7 to 9.

TABLE 7

| | | Decay Performance | | Young's Modulus | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Example 1 | A1 | 0.7 | C | 70 | C | 72 | C | 2 | A |
| Example 2 | A2 | 0.8 | B | 71 | B | 82 | B | 3 | A |
| Example 3 | A3 | 0.9 | A | 72 | A | 93 | A | 5 | A |
| Example 4 | A4 | 1.2 | A | 72 | A | 92 | A | 12 | A |
| Example 5 | A5 | 1.3 | A | 72 | A | 102 | A | 12 | A |
| Example 6 | A6 | 1.4 | A | 72 | A | 121 | A | 23 | A |
| Example 7 | A7 | 2.1 | A | 73 | A | 132 | A | 21 | A |
| Example 8 | A8 | 2.1 | A | 73 | A | 148 | A | 21 | A |
| Example 9 | A9 | 9.2 | A | 74 | A | 189 | A | 28 | A |
| Example 10 | A10 | 4.2 | A | 75 | A | 241 | A | 25 | A |
| Example 11 | A11 | 1.5 | A | 72 | A | 120 | A | 12 | A |
| Example 12 | A12 | 1.4 | A | 73 | A | 134 | A | 13 | A |
| Example 13 | A13 | 1.1 | A | 72 | A | 93 | A | 10 | A |
| Example 14 | A14 | 2.5 | A | 73 | A | 121 | A | 19 | A |
| Example 15 | A15 | 1.2 | A | 72 | A | 121 | A | 11 | A |
| Example 16 | A16 | 1.2 | A | 72 | A | 129 | A | 10 | A |
| Example 17 | A17 | 1.2 | A | 72 | A | 130 | A | 33 | B |
| Example 18 | A18 | 1.3 | A | 73 | A | 133 | A | 48 | B |
| Example 19 | A19 | 1.2 | A | 72 | A | 121 | A | 12 | A |
| Example 20 | A20 | 1.4 | A | 73 | A | 129 | A | 13 | A |
| Example 21 | A21 | 1.8 | A | 79 | A | 192 | A | 14 | A |
| Example 22 | A22 | 1.3 | A | 72 | A | 134 | A | 12 | A |
| Example 23 | A23 | 1.2 | A | 72 | A | 151 | A | 12 | A |
| Example 24 | A24 | 1.1 | A | 75 | A | 175 | A | 11 | A |
| Example 25 | A25 | 1.4 | A | 72 | A | 121 | A | 12 | A |
| Example 26 | A26 | 1.3 | A | 72 | A | 124 | A | 10 | A |
| Example 27 | A27 | 0.8 | B | 72 | A | 201 | A | 21 | A |
| Example 28 | A28 | 1.3 | A | 72 | A | 123 | A | 12 | A |
| Example 29 | A29 | 1.4 | A | 73 | A | 145 | A | 12 | A |
| Example 30 | A30 | 1.8 | A | 75 | A | 182 | A | 14 | A |

TABLE 8

| | | Decay Performance | | Young's Modulus | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Example 31 | A31 | 1.3 | A | 73 | A | 123 | A | 10 | A |
| Example 32 | A32 | 1.3 | A | 74 | A | 171 | A | 12 | A |
| Example 33 | A33 | 1.8 | A | 77 | A | 211 | A | 12 | A |
| Example 34 | A34 | 1.4 | A | 74 | A | 161 | A | 11 | A |
| Example 35 | A35 | 1.3 | A | 73 | A | 152 | A | 13 | A |
| Example 36 | A36 | 1.3 | A | 74 | A | 166 | A | 13 | A |
| Example 37 | A37 | 1.2 | A | 72 | A | 123 | A | 12 | A |
| Example 38 | A38 | 1.6 | A | 74 | A | 162 | A | 11 | A |
| Example 39 | A39 | 3.2 | A | 80 | A | 251 | A | 23 | A |
| Example 40 | A40 | 0.8 | B | 71 | B | 80 | B | 8 | A |
| Example 41 | A41 | 1.8 | A | 74 | A | 161 | A | 12 | A |
| Example 42 | A42 | 2.4 | A | 75 | A | 189 | A | 23 | A |
| Example 43 | A43 | 6.3 | A | 77 | A | 201 | A | 58 | C |
| Example 44 | A44 | 2.8 | A | 75 | A | 135 | A | 59 | C |
| Example 45 | A45 | 1.4 | A | 74 | A | 133 | A | 53 | C |
| Example 46 | A46 | 1.7 | A | 75 | A | 189 | A | 64 | C |
| Example 47 | A47 | 1.4 | A | 74 | A | 165 | A | 60 | C |
| Example 48 | A48 | 1.5 | A | 74 | A | 178 | A | 63 | C |
| Example 49 | A49 | 1.8 | A | 74 | A | 196 | A | 65 | C |
| Example 50 | A50 | 1.3 | A | 74 | A | 171 | A | 59 | C |
| Example 51 | A51 | 1.4 | A | 74 | A | 162 | A | 12 | A |
| Example 52 | A52 | 1.4 | A | 74 | A | 163 | A | 13 | A |
| Example 53 | A53 | 1.3 | A | 73 | A | 160 | A | 14 | A |
| Example 54 | A54 | 1.3 | A | 73 | A | 160 | A | 11 | A |
| Example 55 | A55 | 1.4 | A | 74 | A | 163 | A | 11 | A |
| Example 56 | A56 | 1.4 | A | 74 | A | 161 | A | 10 | A |

TABLE 9

| | | Decay Performance | Young's Modulus | | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Comparative | AC1 | 0.6 | D | 68 | D | 45 | D | 1 | A |
| Example 1 | | | | | | | | | |
| Comparative | AC2 | 0.5 | D | 67 | D | 42 | D | 3 | A |
| Example 2 | | | | | | | | | |
| Comparative | AC3 | 0.6 | D | 68 | D | 43 | D | 8 | A |
| Example 3 | | | | | | | | | |
| Comparative | AC4 | 0.5 | D | 67 | D | 42 | D | 7 | A |
| Example 4 | | | | | | | | | |
| Comparative | AC5 | 0.5 | D | 67 | D | 40 | D | 5 | A |
| Example 5 | | | | | | | | | |
| Comparative | AC6 | 0.5 | D | 67 | D | 182 | A | 3 | A |
| Example 6 | | | | | | | | | |
| Comparative | AC7 | 0.4 | D | 67 | D | 231 | A | 4 | A |
| Example 7 | | | | | | | | | |
| Comparative | AC8 | 0.5 | D | 67 | D | 40 | D | 6 | A |
| Example 8 | | | | | | | | | |
| Comparative | AC9 | 0.5 | D | 67 | D | 40 | D | 5 | A |
| Example 9 | | | | | | | | | |
| Comparative | AC10 | 0.5 | D | 67 | D | 39 | D | 3 | A |
| Example 10 | | | | | | | | | |
| Comparative | AC11 | 0.5 | D | 71 | B | 52 | D | 12 | A |
| Example 11 | | | | | | | | | |
| Comparative | AC12 | — | — | — | — | — | — | 13 | A |
| Example 12 | | | | | | | | | |
| Comparative | AC13 | 0.5 | D | 71 | B | 68 | D | 13 | A |
| Example 13 | | | | | | | | | |
| Comparative | AC14 | — | — | — | — | — | — | 12 | A |
| Example 14 | | | | | | | | | |
| Comparative | AC15 | 0.4 | D | 70 | C | 53 | D | 12 | A |
| Example 15 | | | | | | | | | |
| Comparative | AC16 | 0.4 | D | 70 | C | 62 | D | 14 | A |
| Example 16 | | | | | | | | | |
| Comparative | AC17 | 0.4 | D | 70 | C | 49 | D | 4 | A |
| Example 17 | | | | | | | | | |
| Comparative | AC18 | 0.4 | D | 70 | C | 51 | D | 3 | A |
| Example 18 | | | | | | | | | |
| Comparative | AC19 | 0.5 | D | 72 | A | 62 | D | 19 | A |
| Example 19 | | | | | | | | | |
| Comparative | AC20 | 0.5 | D | 72 | A | 68 | D | 21 | A |
| Example 20 | | | | | | | | | |

[Young's Modulus]

A sample of 60 mm×8 mm was collected from the aluminum alloy substrate obtained after the heat treatment (step S109) step, and a Young's modulus was measured by a resonance method. The Young's modulus was measured at room temperature using a JE-RT type device manufactured by Nihon Techno-Plus Corp. In the evaluation of the Young's modulus, a Young's modulus of 72 GPa or more was evaluated as A (excellent), a Young's modulus of 71 GPa or more and less than 72 GPa was evaluated as B (good), a Young's modulus of 70 GPa or more and less than 71 GPa was evaluated as C (fair), and a Young's modulus of less than 70 GPa was evaluated as D (poor). It is also acceptable to peel the plating of a magnetic disk or aluminum alloy base obtained after the heat treatment, collect a test piece from the substrate of which the surface of 10 μm was ground, and perform the evaluation described above. The results are set forth in Tables 7 to 9.

[Proof Stress]

Proof stress was measured in conformity with JIS Z2241 by performing annealing (pressurization annealing simulated heating), at 230° C. for 3 hours, of the aluminum alloy sheet subjected to the cold rolling (step S105), then performing heat treatment under the conditions set forth in Tables 4 to 6, collecting JIS No. 5 test pieces along the rolling direction, and setting n=2. In the evaluation of the strength, a proof stress of 90 MPa or more was evaluated as A (excellent), a proof stress of 80 MPa or more and less than 90 MPa was evaluated as B (good), a proof stress of 70 MPa or more and less than 80 MPa was evaluated as C (fair), and a proof stress of less than 70 MPa was evaluated as D (poor). The results are set forth in Tables 7 to 9. It is also possible to collect a test piece from an aluminum alloy substrate obtained after the heat treatment or from a substrate obtained by peeling the plating of an aluminum alloy base or magnetic disk and grinding a surface of 10 μm, and perform the evaluation of proof stress. As the dimensions of the test piece in such a case, the width of a parallel portion is set at 5±0.14 mm, the original gage length of the test piece is set at 10 mm, the radius of the shoulder is set at 2.5 mm, and the length of the parallel portion is set at 15 mm.

[Productivity]

Visual inspection was performed using the aluminum alloy sheet obtained after the cold rolling (step S105). A case in which the length of a crack along a surface was less than 30 mm was evaluated as A, a case in which a crack having a length of 30 to 50 mm was generated along a surface was evaluated as B, and a case in which a crack of more than 50 mm was generated along a surface was evaluated as C. The results are set forth in Tables 7 to 9.

As set forth in Tables 7 and 8, decay performance, a Young's modulus, a proof stress, and productivity were excellent, and favorable shock resistance was able to be obtained in each of Examples 1 to 56.

In contrast, as set forth in Table 9, any of decay performance, a Young's modulus, and a proof stress was poor, and therefore, favorable shock resistance was not able to be obtained in Comparative Examples 1 to 20.

Specifically, Comparative Example 1 resulted in the excessively small content of Fe in an aluminum alloy, and was therefore poor in decay performance, Young's modulus, and proof stress.

Comparative Example 2 resulted in the excessively small content of Mn in an aluminum alloy, and was therefore poor in decay performance, Young's modulus, and proof stress.

Comparative Example 3 resulted in the excessively small content of Si in an aluminum alloy, and was therefore poor in decay performance, Young's modulus, and proof stress.

Comparative Example 4 resulted in the excessively small content of Ni in an aluminum alloy, and was therefore poor in decay performance, Young's modulus, and proof stress.

Comparative Example 5 resulted in the excessively small content of Cu in an aluminum alloy, and was therefore poor in decay performance, Young's modulus, and proof stress.

Comparative Example 6 resulted in the excessively large content of Mg in an aluminum alloy, and was therefore poor in decay performance and Young.

Comparative Example 7 resulted in the excessively small content of Fe, the excessively small content of Si, and the excessively large content of Mg in an aluminum alloy, and was therefore poor in decay performance and Young.

Comparative Example 8 resulted in the excessively small content of Cr, and was therefore poor in decay performance, Young's modulus, and proof stress.

Comparative Example 9 resulted in the excessively small content of Zr, and was therefore poor in decay performance, Young's modulus, and proof stress.

Comparative Example 10 resulted in the excessively small content of Zn, and was therefore poor in decay performance, Young's modulus, and proof stress.

Comparative Example 11 resulted in an excessively high heating retention temperature in a heat treatment step, and was therefore poor in decay performance and proof stress.

In Comparative Example 12, a heating retention temperature was excessively low, and heating retention time was excessively short in a heat treatment step. Therefore, flatness after a lapse of 1 week following the heat treatment step was deteriorated by 20 μm or more, and evaluation was not performed.

Comparative Example 13 resulted in excessively long heating retention time in a heat treatment step, and was therefore poor in decay performance and proof stress.

In Comparative Example 14, heating retention time was excessively short in a heat treatment step. Therefore, flatness after a lapse of 1 week following the heat treatment step was deteriorated by 20 μm or more, and evaluation was not performed.

Comparative Example 15 resulted in an excessively high heating retention temperature in a heat treatment step, and was therefore poor in decay performance and proof stress.

Comparative Example 16 resulted in excessively long heating retention time in a heat treatment step, and was therefore poor in decay performance and proof stress.

Comparative Example 17 resulted in the excessively small content of Fe in an aluminum alloy and in an excessively high heating retention temperature in a heat treatment step, and was therefore poor in decay performance and proof stress.

Comparative Example 18 resulted in the excessively small content of Fe in an aluminum alloy and in excessively long heating retention time in a heat treatment step, and was therefore poor in decay performance and proof stress.

Comparative Example 19 resulted in an excessively high heating retention temperature in a heat treatment step, and was therefore poor in decay performance and proof stress.

Comparative Example 20 resulted in excessively long heating retention time in a heat treatment step, and was therefore poor in decay performance and proof stress.

An example of an aluminum alloy substrate for a magnetic disk using an aluminum alloy cast by a CC casting method will now be described as a second example. In a manner similar to the manner of the first example, each alloy material with component composition set forth in Tables 1 to 3 was melted to make a molten aluminum alloy according to a usual method (step S101).

Then, the molten aluminum alloy was cast by the CC casting method, to produce a cast sheet having a thickness of 8 mm (step S102).

Then, the cast sheets of the alloys other than No. A1 were subjected to annealing (batch type) under conditions of 450° C. and 2 hours. All the cast sheets produced in such a manner were rolled to have a final sheet thickness of 0.8 mm by cold rolling (rolling reduction of 90.0%), to make aluminum alloy sheets (step S105). Disk blanks were stamped and produced to have an annular shape with an outer diameter of 96 mm and an inner diameter of 24 mm from the aluminum alloy sheets (step S106).

Each of the disk blanks produced in such a manner was subjected to pressurization annealing (pressurization flattening treatment) for 3 hours at 230° C. (step S107). The disk blank was subjected to end-surface preparation (cutting work) to have an outer diameter of 95 mm and an inner diameter of 25 mm and subjected to grinding work (grinding work of surface of 25 μm) (step S108). Then, heat treatment was performed under conditions set forth in Tables 10 to 12 (step S109). A retention time of “0.0 h” in a range of 130 to 280° C. in Comparative Example 32 in Table 12 represents a heating retention temperature of less than 130° C.

TABLE 10

Heat Treatment Conditions

| | | Heating | Retention Time |
|---|---|---|---|
| | | Retention | in Range of |
| | | Temperature | 130 to 280° C. |
| | Alloy No. | (° C.) | (h) |
| Example 57 | A1 | 130 | 10.0 |
| Example 58 | A2 | 180 | 5.0 |
| Example 59 | A3 | 200 | 0.5 |
| Example 60 | A4 | 230 | 1.0 |
| Example 61 | A5 | 230 | 1.0 |
| Example 62 | A6 | 250 | 1.0 |
| Example 63 | A7 | 230 | 1.0 |
| Example 64 | A8 | 230 | 1.0 |
| Example 65 | A9 | 200 | 1.0 |
| Example 66 | A10 | 280 | 1.0 |
| Example 67 | A11 | 230 | 1.0 |
| Example 68 | A12 | 230 | 1.0 |
| Example 69 | A13 | 230 | 1.0 |
| Example 70 | A14 | 230 | 1.0 |
| Example 71 | A15 | 230 | 1.0 |
| Example 72 | A16 | 230 | 1.0 |
| Example 73 | A17 | 230 | 1.0 |
| Example 74 | A18 | 230 | 1.0 |
| Example 75 | A19 | 230 | 1.0 |
| Example 76 | A20 | 230 | 1.0 |
| Example 77 | A21 | 230 | 1.0 |
| Example 78 | A22 | 230 | 1.0 |
| Example 79 | A23 | 230 | 1.0 |
| Example 80 | A24 | 230 | 1.0 |
| Example 81 | A25 | 230 | 1.0 |
| Example 82 | A26 | 230 | 1.0 |
| Example 83 | A27 | 230 | 1.0 |
| Example 84 | A28 | 230 | 1.0 |
| Example 85 | A29 | 230 | 1.0 |
| Example 86 | A30 | 230 | 1.0 |

TABLE 11

Heat Treatment Conditions

| | | Heating | Retention Time |
|---|---|---|---|
| | | Retention | in Range of |
| | | Temperature | 130 to 280° C. |
| | Alloy No. | (° C.) | (h) |
| Example 87 | A31 | 230 | 1.0 |
| Example 88 | A32 | 230 | 1.0 |
| Example 89 | A33 | 230 | 1.0 |
| Example 90 | A34 | 230 | 1.0 |
| Example 91 | A35 | 230 | 1.0 |
| Example 92 | A36 | 230 | 1.0 |
| Example 93 | A37 | 230 | 1.0 |
| Example 94 | A38 | 230 | 1.0 |
| Example 95 | A39 | 230 | 1.0 |
| Example 96 | A40 | 230 | 1.0 |
| Example 97 | A41 | 230 | 1.0 |
| Example 98 | A42 | 230 | 1.0 |
| Example 99 | A43 | 230 | 1.0 |
| Example 100 | A44 | 230 | 1.0 |
| Example 101 | A45 | 230 | 1.0 |
| Example 102 | A46 | 230 | 1.0 |
| Example 103 | A47 | 230 | 1.0 |
| Example 104 | A48 | 230 | 1.0 |
| Example 105 | A49 | 230 | 1.0 |
| Example 106 | A50 | 230 | 1.0 |
| Example 107 | A51 | 230 | 1.0 |
| Example 108 | A52 | 230 | 1.0 |
| Example 109 | A53 | 230 | 1.0 |
| Example 110 | A54 | 230 | 1.0 |
| Example 111 | A55 | 230 | 1.0 |
| Example 112 | A56 | 230 | 1.0 |

TABLE 12

| | | Heat Treatment Conditions | |
|---|---|---|---|
| | | Heating | Retention Time |
| | | Retention | in Range of |
| | | Temperature | 130 to 280° C. |
| | Alloy No. | (° C.) | (h) |
| Comparative Example 21 | AC1 | 230 | 1.0 |
| Comparative Example 22 | AC2 | 230 | 1.0 |
| Comparative Example 23 | AC3 | 230 | 1.0 |
| Comparative Example 24 | AC4 | 230 | 1.0 |
| Comparative Example 25 | AC5 | 230 | 1.0 |
| Comparative Example 26 | AC6 | 230 | 1.0 |
| Comparative Example 27 | AC7 | 230 | 1.0 |
| Comparative Example 28 | AC8 | 230 | 1.0 |
| Comparative Example 29 | AC9 | 230 | 1.0 |
| Comparative Example 30 | AC10 | 230 | 1.0 |
| Comparative Example 31 | AC11 | 350 | 1.0 |
| Comparative Example 32 | AC12 | 100 | 0.0 |
| Comparative Example 33 | AC13 | 230 | 12.0 |
| Comparative Example 34 | AC14 | 230 | 0.3 |
| Comparative Example 35 | AC15 | 300 | 1.0 |
| Comparative Example 36 | AC16 | 230 | 12.0 |
| Comparative Example 37 | AC17 | 350 | 1.0 |
| Comparative Example 38 | AC18 | 230 | 12.0 |
| Comparative Example 39 | AC19 | 350 | 1.0 |
| Comparative Example 40 | AC20 | 230 | 12.0 |

The following evaluations of the aluminum alloy sheets obtained after the cold rolling (step S105) and the aluminum alloy substrates obtained after the heat treatment (step S109) were performed. Visual inspection of each sample was performed after the cold rolling. As a result, cracks of having a length of 30 to 50 mm were generated along a surface in Examples 73 and 74, and cracks having a length of more than 50 mm were generated along a surface in Examples 99 to 106. However, a portion in which no crack was generated was used as a sample, and subjected to trial production and evaluations. The flatness of each sample was measured just after the heat treatment step and after a lapse of 1 week following the heat treatment step. In Comparative Examples 32 and 34, flatness after a lapse of 1 week following the heat treatment step was deteriorated by 20 μm or more, and inappropriate for an aluminum alloy substrate for a magnetic disk, and the following evaluations were not performed.

[Loss Factor×Sheet Thickness]

A sample of 60 mm×8 mm was collected from the aluminum alloy substrate obtained after the heat treatment (step S109) step, a loss factor was measured by a vibration decay method, and loss factor×sheet thickness (mm) was calculated. The loss factor was measured at room temperature using a JE-RT type device manufactured by Nihon Techno-Plus Corp. In the evaluation of decay performance, a case in which loss factor×sheet thickness was 0.9×10⁻³ or more was evaluated as A (excellent), a case in which loss factor×sheet thickness was 0.8×10⁻³ or more and less than 0.9×10⁻³ was evaluated as B (good), a case in which loss factor×sheet thickness was 0.7×10⁻³ or more and less than 0.8×10⁻³ was evaluated as C (fair), and a case in which loss factor×sheet thickness was less than 0.7×10⁻³ was evaluated as D (poor). It is also acceptable to peel the plating of a magnetic disk or aluminum alloy base obtained after the heat treatment, collect a test piece from the substrate of which the surface of 10 μm was ground, and perform the evaluation. The results are set forth in Tables 13 to 15.

TABLE 13

| | | Decay Performance | | Young's Modulus | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Example 57 | A1 | 0.7 | C | 70 | C | 78 | C | 4 | A |
| Example 58 | A2 | 0.8 | B | 71 | B | 88 | B | 4 | A |
| Example 59 | A3 | 0.9 | A | 72 | A | 96 | A | 6 | A |
| Example 60 | A4 | 1.2 | A | 72 | A | 98 | A | 13 | A |
| Example 61 | A5 | 1.0 | A | 72 | A | 106 | A | 12 | A |
| Example 62 | A6 | 1.3 | A | 72 | A | 129 | A | 25 | A |
| Example 63 | A7 | 2.0 | A | 73 | A | 134 | A | 22 | A |
| Example 64 | A8 | 2.1 | A | 73 | A | 152 | A | 23 | A |
| Example 65 | A9 | 8.9 | A | 74 | A | 191 | A | 28 | A |
| Example 66 | A10 | 4.1 | A | 74 | A | 279 | A | 25 | A |
| Example 67 | A11 | 1.4 | A | 72 | A | 124 | A | 12 | A |
| Example 68 | A12 | 1.4 | A | 73 | A | 144 | A | 13 | A |
| Example 69 | A13 | 1.1 | A | 72 | A | 99 | A | 10 | A |
| Example 70 | A14 | 2.4 | A | 73 | A | 125 | A | 21 | A |
| Example 71 | A15 | 1.2 | A | 72 | A | 128 | A | 11 | A |
| Example 72 | A16 | 1.2 | A | 72 | A | 132 | A | 11 | A |
| Example 73 | A17 | 1.2 | A | 72 | A | 135 | A | 36 | B |
| Example 74 | A18 | 1.3 | A | 73 | A | 137 | A | 47 | B |
| Example 75 | A19 | 1.2 | A | 72 | A | 126 | A | 10 | A |
| Example 76 | A20 | 1.3 | A | 73 | A | 139 | A | 13 | A |
| Example 77 | A21 | 1.7 | A | 78 | A | 198 | A | 14 | A |
| Example 78 | A22 | 1.3 | A | 72 | A | 138 | A | 11 | A |
| Example 79 | A23 | 1.2 | A | 72 | A | 152 | A | 12 | A |
| Example 80 | A24 | 1.1 | A | 75 | A | 185 | A | 11 | A |
| Example 81 | A25 | 1.4 | A | 72 | A | 123 | A | 12 | A |
| Example 82 | A26 | 1.3 | A | 72 | A | 127 | A | 9 | A |
| Example 83 | A27 | 0.8 | B | 72 | A | 211 | A | 24 | A |
| Example 84 | A28 | 1.3 | A | 72 | A | 126 | A | 13 | A |
| Example 85 | A29 | 1.4 | A | 73 | A | 148 | A | 8 | A |
| Example 86 | A30 | 1.7 | A | 75 | A | 192 | A | 11 | A |

TABLE 14

| | | Decay Performance | | Young's Modulus | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Example 87 | A31 | 1.3 | A | 73 | A | 133 | A | 11 | A |
| Example 88 | A32 | 1.3 | A | 74 | A | 175 | A | 13 | A |
| Example 89 | A33 | 1.7 | A | 77 | A | 221 | A | 11 | A |
| Example 90 | A34 | 1.4 | A | 74 | A | 171 | A | 10 | A |
| Example 91 | A35 | 1.3 | A | 73 | A | 162 | A | 9 | A |
| Example 92 | A36 | 1.3 | A | 74 | A | 169 | A | 10 | A |
| Example 93 | A37 | 1.2 | A | 72 | A | 133 | A | 11 | A |
| Example 94 | A38 | 1.5 | A | 74 | A | 168 | A | 13 | A |
| Example 95 | A39 | 3.1 | A | 79 | A | 271 | A | 19 | A |
| Example 96 | A40 | 0.8 | B | 71 | B | 85 | B | 11 | A |
| Example 97 | A41 | 1.7 | A | 74 | A | 165 | A | 14 | A |
| Example 98 | A42 | 2.2 | A | 75 | A | 198 | A | 24 | A |
| Example 99 | A43 | 6.1 | A | 76 | A | 221 | A | 63 | C |
| Example 100 | A44 | 2.6 | A | 75 | A | 145 | A | 60 | C |
| Example 101 | A45 | 1.4 | A | 74 | A | 138 | A | 55 | C |
| Example 102 | A46 | 1.7 | A | 75 | A | 196 | A | 60 | C |
| Example 103 | A47 | 1.4 | A | 74 | A | 175 | A | 59 | C |
| Example 104 | A48 | 1.5 | A | 74 | A | 188 | A | 59 | C |
| Example 105 | A49 | 1.7 | A | 74 | A | 201 | A | 58 | C |
| Example 106 | A50 | 1.3 | A | 74 | A | 172 | A | 58 | C |
| Example 107 | A51 | 1.4 | A | 74 | A | 174 | A | 10 | A |
| Example 108 | A52 | 1.3 | A | 73 | A | 175 | A | 9 | A |
| Example 109 | A53 | 1.3 | A | 73 | A | 170 | A | 11 | A |
| Example 110 | A54 | 1.4 | A | 74 | A | 171 | A | 9 | A |
| Example 111 | A55 | 1.4 | A | 74 | A | 174 | A | 13 | A |
| Example 112 | A56 | 1.4 | A | 74 | A | 172 | A | 10 | A |

TABLE 15

| | | Decay Performance | | Young's Modulus | | Strength | | Productivity | |
|---|---|---|---|---|---|---|---|---|---|
| | | Loss Factor × | | Young's | | Proof | | Crack | |
| | Alloy | Sheet Thickness | | Modulus | | Stress | | Length | |
| | No. | (×10⁻³) | Evaluation | (GPa) | Evaluation | (MPa) | Evaluation | (mm) | Evaluation |
| Comparative | AC1 | 0.5 | D | 68 | D | 49 | D | 2 | A |
| Example 21 | | | | | | | | | |
| Comparative | AC2 | 0.5 | D | 67 | D | 45 | D | 1 | A |
| Example 22 | | | | | | | | | |
| Comparative | AC3 | 0.5 | D | 68 | D | 45 | D | 6 | A |
| Example 23 | | | | | | | | | |
| Comparative | AC4 | 0.5 | D | 67 | D | 43 | D | 5 | A |
| Example 24 | | | | | | | | | |
| Comparative | AC5 | 0.5 | D | 67 | D | 41 | D | 4 | A |
| Example 25 | | | | | | | | | |
| Comparative | AC6 | 0.5 | D | 67 | D | 188 | A | 3 | A |
| Example 26 | | | | | | | | | |
| Comparative | AC7 | 0.4 | D | 67 | D | 238 | A | 4 | A |
| Example 27 | | | | | | | | | |
| Comparative | AC8 | 0.4 | D | 67 | D | 45 | D | 7 | A |
| Example 28 | | | | | | | | | |
| Comparative | AC9 | 0.5 | D | 67 | D | 45 | D | 6 | A |
| Example 29 | | | | | | | | | |
| Comparative | AC10 | 0.5 | D | 67 | D | 42 | D | 4 | A |
| Example 30 | | | | | | | | | |
| Comparative | AC11 | 0.5 | D | 71 | B | 56 | D | 10 | A |
| Example 31 | | | | | | | | | |
| Comparative | AC12 | — | — | — | — | — | — | 12 | A |
| Example 32 | | | | | | | | | |
| Comparative | AC13 | 0.5 | D | 71 | B | 69 | D | 11 | A |
| Example 33 | | | | | | | | | |
| Comparative | AC14 | — | — | — | — | — | — | 11 | A |
| Example 34 | | | | | | | | | |
| Comparative | AC15 | 0.4 | D | 70 | C | 55 | D | 13 | A |
| Example 35 | | | | | | | | | |
| Comparative | AC16 | 0.4 | D | 70 | C | 64 | D | 12 | A |
| Example 36 | | | | | | | | | |
| Comparative | AC17 | 0.4 | D | 70 | C | 51 | D | 5 | A |
| Example 37 | | | | | | | | | |
| Comparative | AC18 | 0.4 | D | 70 | C | 53 | D | 4 | A |
| Example 38 | | | | | | | | | |
| Comparative | AC19 | 0.5 | D | 72 | A | 67 | D | 21 | A |
| Example 39 | | | | | | | | | |
| Comparative | AC20 | 0.5 | D | 72 | A | 69 | D | 19 | A |
| Example 40 | | | | | | | | | |

[Young's Modulus]

A sample of 60 mm×8 mm was collected from the aluminum alloy substrate obtained after the heat treatment (step S109) step, and a Young's modulus was measured by a resonance method. The Young's modulus was measured at room temperature using a JE-RT type device manufactured by Nihon Techno-Plus Corp. In the evaluation of the Young's modulus, a Young's modulus of 72 GPa or more was evaluated as A (excellent), a Young's modulus of 71 GPa or more and less than 72 GPa was evaluated as B (good), a Young's modulus of 70 GPa or more and less than 71 GPa was evaluated as C (fair), and a Young's modulus of less than 70 GPa was evaluated as D (poor). It is also acceptable to peel the plating of a magnetic disk or aluminum alloy base obtained after the heat treatment, collect a test piece from the substrate of which the surface of 10 μm was ground, and perform the evaluation described above. The results are set forth in Tables 13 to 15.

[Proof Stress]

Proof stress was measured in conformity with JIS Z2241 by performing annealing (pressurization annealing simulated heating), at 230° C. for 3 hours, of the aluminum alloy sheet subjected to the cold rolling (step S105), then performing heat treatment under the conditions set forth in Tables 10 to 12, collecting JIS No. 5 test pieces along the rolling direction, and setting n=2. In the evaluation of the strength, a proof stress of 90 MPa or more was evaluated as A (excellent), a proof stress of 80 MPa or more and less than 90 MPa was evaluated as B (good), a proof stress of 70 MPa or more and less than 80 MPa was evaluated as C (fair), and a proof stress of less than 70 MPa was evaluated as D (poor). The results are set forth in Tables 13 to 15. It is also possible to collect a test piece from an aluminum alloy substrate obtained after the heat treatment or from a substrate obtained by peeling the plating of an aluminum alloy base or magnetic disk and grinding a surface of 10 μm, and perform the evaluation of proof stress. As the dimensions of the test piece in such a case, the width of a parallel portion is set at 5±0.14 mm, the original gage length of the test piece is set at 10 mm, the radius of the shoulder is set at 2.5 mm, and the length of the parallel portion is set at 15 mm.

[Productivity]

Visual inspection was performed using the aluminum alloy sheet obtained after the cold rolling (step S105). A case in which the length of a crack along a surface was less than 30 mm was evaluated as A, a case in which a crack having a length of 30 to 50 mm was generated along a surface was evaluated as B, and a case in which a crack of more than 50 mm was generated along a surface was evaluated as C. The results are set forth in Tables 13 to 15.

As set forth in Tables 13 and 14, decay performance, a Young's modulus, a proof stress, and productivity were excellent, and favorable shock resistance was able to be obtained in each of Examples 57 to 112.

In contrast, as set forth in Table 15, any of decay performance, a Young's modulus, and a proof stress was poor, and therefore, favorable shock resistance was not able to be obtained in Comparative Examples 21 to 40.

Specifically, Comparative Example 21 resulted in the excessively small content of Fe in an aluminum alloy, and was therefore poor in decay performance, Young's modulus, and proof stress.

Comparative Example 22 resulted in the excessively small content of Mn in an aluminum alloy, and was therefore poor in decay performance, Young's modulus, and proof stress.

Comparative Example 23 resulted in the excessively small content of Si in an aluminum alloy, and was therefore poor in decay performance, Young's modulus, and proof stress.

Comparative Example 24 resulted in the excessively small content of Ni in an aluminum alloy, and was therefore poor in decay performance, Young's modulus, and proof stress.

Comparative Example 25 resulted in the excessively small content of Cu in an aluminum alloy, and was therefore poor in decay performance, Young's modulus, and proof stress.

Comparative Example 26 resulted in the excessively large content of Mg in an aluminum alloy, and was therefore poor in decay performance and Young.

Comparative Example 27 resulted in the excessively small content of Fe, the excessively small content of Si, and the excessively large content of Mg in an aluminum alloy, and was therefore poor in decay performance and Young.

Comparative Example 28 resulted in the excessively small content of Cr, and was therefore poor in decay performance, Young's modulus, and proof stress.

Comparative Example 29 resulted in the excessively small content of Zr, and was therefore poor in decay performance, Young's modulus, and proof stress.

Comparative Example 30 resulted in the excessively small content of Zn, and was therefore poor in decay performance, Young's modulus, and proof stress.

Comparative Example 31 resulted in an excessively high heating retention temperature in a heat treatment step, and was therefore poor in decay performance and proof stress.

In Comparative Example 32, a heating retention temperature was excessively low, and heating retention time was excessively short in a heat treatment step. Therefore, flatness after a lapse of 1 week following the heat treatment step was deteriorated by 20 μm or more, and evaluation was not performed.

Comparative Example 33 resulted in excessively long heating retention time in a heat treatment step, and was therefore poor in decay performance and proof stress.

In Comparative Example 34, heating retention time was excessively short in a heat treatment step. Therefore, flatness after a lapse of 1 week following the heat treatment step was deteriorated by 20 μm or more, and evaluation was not performed.

Comparative Example 35 resulted in an excessively high heating retention temperature in a heat treatment step, and was therefore poor in decay performance and proof stress.

Comparative Example 36 resulted in excessively long heating retention time in a heat treatment step, and was therefore poor in decay performance and proof stress.

Comparative Example 37 resulted in the excessively small content of Fe in an aluminum alloy and in an excessively high heating retention temperature in a heat treatment step, and was therefore poor in decay performance and proof stress.

Comparative Example 38 resulted in the excessively small content of Fe in an aluminum alloy and in excessively long heating retention time in a heat treatment step, and was therefore poor in decay performance and proof stress.

Comparative Example 39 resulted in an excessively high heating retention temperature in a heat treatment step, and was therefore poor in decay performance and proof stress.

Comparative Example 40 resulted in excessively long heating retention time in a heat treatment step, and was therefore poor in decay performance and proof stress.

### INDUSTRIAL APPLICABILITY

An aluminum alloy substrate for a magnetic disk, excellent in shock resistance, a method for producing the aluminum alloy substrate for a magnetic disk, and a magnetic disk using the aluminum alloy substrate for a magnetic disk are obtained by the present disclosure.

1. An aluminum alloy substrate for a magnetic disk, wherein a product of a sheet thickness (mm) and a loss factor of the aluminum alloy substrate is 0.7×10⁻³ or more.

2. The aluminum alloy substrate according to claim 1, wherein the aluminum alloy substrate has a Young's modulus of 70 GPa or more and a proof stress of 70 MPa or more.

3. The aluminum alloy substrate according to claim 1, comprising an aluminum alloy comprising one or more selected from a group comprising 0.10 to 3.00 mass % of Fe 0.10 to 3.00 mass % of Mn, and optionally (1) at least one selected from a group comprising 0.100 to 5.000 mass % or Mg, 0.100 to 5.000 mass % of Ni, 0.010 to 5.000 mass % of Cr, 0.010 to 5.000 mass % of Zr, 0.005 to 5.000 mass % of Zn, 0.005 to 5.000 mass % of Cu, and 0.10 to 0.40 mass % of Si, (2) one or more selected a group comprising Ti, B, and V of which a total of contents is 0.005 to 5.000 mass %, or combination of (1) and (2), with a balance of Al and unavoidable impurities.

4. (canceled)

5. (canceled)

6. A magnetic disk, wherein an electroless Ni—P plating treatment layer and a magnetic layer formed thereon are disposed on a surface of the aluminum alloy substrate according to claim 1.

7. A method for producing an aluminum alloy substrate, the method comprising a semi-continuous casting step of semi-continuously casting an ingot using an aluminum alloy, a hot-rolling step of hot-rolling the ingot, a cold-rolling step of cold-rolling the hot-rolled sheet, a disk blank stamping step of stamping the cold-rolled sheet to have an annular shape, a pressurization annealing step of subjecting the stamped disk blank to pressurization annealing, a cutting/grinding step of performing cutting work and grinding work of the blank subjected to the pressurization annealing, and a heat treatment step of heat-treating the cut and ground blank, wherein heating retention of the blank is performed for 0.5 to 10.0 hours at 130 to 280° C. in the heat treatment step.

8. The method according to claim 7, further comprising a homogenization heat treatment step of performing homogenization heat treatment of the ingot between the semi-continuous casting step and the hot-rolling step.

9. The method according to claim 7, further comprising an annealing treatment step of annealing the rolled sheet before or in the cold-rolling step.

10. A method for producing an aluminum alloy substrate, the method comprising a continuous casting step of continuously casting a cast sheet using an aluminum alloy, a cold-rolling step of cold-rolling the cast sheet, a disk blank stamping step of stamping the cold-rolled sheet to have an annular shape, a pressurization annealing step of subjecting the stamped disk blank to pressurization annealing, a cutting/grinding step of performing cutting work and grinding work of the blank subjected to the pressurization annealing, and a heat treatment step of heat-treating the cut and ground blank, wherein heating retention of the blank is performed for 0.5 to 10.0 hours at 130 to 280° C. in the heat treatment step.

11. The method according to claim 10, further comprising an annealing treatment step of annealing the cast sheet or the rolled sheet before or in the cold-rolling step.
